(19) United States
(12) Patent Application Publication
(10) Pub. No.: US 2024/0419161 A1
(43) Pub. Date: Dec. 19, 2024

(54) METHOD FOR CONSTRUCTING A DECISION TREE FOR DIAGNOSING A SYSTEM, METHOD FOR DIAGNOSING THE SYSTEM, DEVICES AND COMPUTER PROGRAMS THEREOF

(71) Applicants: Centre National de la Recherche Scientifique, Paris (FR); Institut National des Sciences Appliquées de Toulouse, Toulouse (FR); ATOS France, Bezons (FR)

(72) Inventors: Louis GOUPIL, Toulouse (FR); Louise TRAVÉ-MASSUYÈS, Caraman (FR); Élodie CHANTHERY, Toulouse (FR)

(73) Assignees: Centre National de la Recherche Scientifique, Paris (FR); Institut National des Sciences Appliquées de Toulouse, Toulouse (FR); ATOS France, Bezons (FR)

(21) Appl. No.: 18/742,520

(22) Filed: Jun. 13, 2024

(30) Foreign Application Priority Data
Jun. 13, 2023 (EP) 23305938.5

(51) Int. Cl. G05B 23/02

(52) U.S. Cl. CPC G05B 23/024

(57) ABSTRACT

A method and device for constructing a decision tree for diagnosing a system with components. The method includes obtaining a training data set comprising pairs with a vector of measured values of observable variables representing a system operation and a label. The label represents a nominal operating state of the system or a failure state of one component. The method includes processing a current node created by splitting a previous node and associated with a subset of the training data set as a current data set. When a splitting criterion is satisfied, splitting the current node into a first and a second child node by applying a classification function obtained from the current data set and defined to a nominal class representing the nominal operating state of the system or a failure class representing the failure states of the system. The method includes providing a decision tree for system diagnosis.

This application claims priority to European Patent Application Number 23305938.5, filed 13 Jun. 2023, the specification of which is hereby incorporated herein by reference.

### BACKGROUND OF THE INVENTION

### Field of the Invention

One or more embodiments of the invention relates to diagnosing a complex industrial system for which the mathematical equations governing the operation thereof are not known.

### Description of the Related Art

In order to diagnose a complex industrial system, it is necessary to detect the different types of failure (or faults) that can occur and to isolate them, that is, to determine which component(s) or sub-system(s) are responsible.

To diagnose a complex industrial system described by numerous equations which may be linear or non-linear, a so-called structural analysis method exists, which disregards these equations, retaining only the links between their variables. The variables in question are observable variables of the system to be diagnosed, for which measurement values are acquired by sensors. The structural analysis exploits a redundancy between these variables in order to determine analytical redundancy relations (ARRs), which are used to construct failure indicators. Each ARR is associated with a given failure state; it is not checked when the system is in the given failure state and is checked when the system is operating normally.

Following the principles of the structural analysis approach, for example described in the paper by Goupil et al., entitled “A survey on diagnosis methods combining dynamic systems, structural analysis and machine learning”, published in the DX2022 conference, HAL ID: hal-03773707, in 2022, a structural model of the system is constructed, usually in the form of a graph, comprising sub-graphs which have certain properties and represent parts of the system. Each part of the system is associated with an ARR which links the observable variables present in that part of the system.

More precisely, structural analysis seeks to construct structurally redundant sub-systems of equations, that is, residuals can be generated from the equations of each of these sub-systems. Ideally, the aim is to obtain sub-systems with minimal redundancy, known as MSOs (Minimally Structurally Overdetermined), that is, they have exactly one more equation than the number of unknown variables. This means that residuals can be generated using the equations of this sub-system. In this respect, methods exist for determining the analytical expression of a residual generator. As an example, the article by Trave-Massuyes et al., is cited entitled “Diagnosability analysis based on component-supported analytical redundancy relations”, published in the journal “IEEE Transactions on System, Man, and Cybernetics-Part A: Systems and Humans”, 36 (6): 1146-1160, in 2006. In a diagnosis application, only the parts of the sub-system impacted by at least one type of system failure are taken into consideration and such a residual generator can then be used to diagnose failures or faults in a support for failures or faults that impact the part of the sub-system, that is to which it is sensitive.

One shortcoming of this structural analysis method applied to the diagnosis of a complex industrial system is that it requires in-depth knowledge of the system, that is of the mathematical equations governing the operation of the system. However, it is often not known what they are, not to mention the fact that nowadays, the trend is for industrial systems to become increasingly complex, which means that the systems of equations governing them are themselves becoming more complex, making it increasingly difficult to apply this structural analysis method thereto.

Approaches combining machine learning with the structural analysis method have been proposed, notably for identifying ARR expression by machine learning. In this regard, one such example is the paper by Jung et al., entitled “Automatic design of grey-box recurrent neural networks for fault diagnosis using structural models and causal information”, published in the Proceedings of the Conference on Learnings for Dynamics and Control, in 2022. This method improves the performance of system failure diagnosis.

However, it is still necessary to know the variables involved in the mathematical equations of the system, which makes the method unusable for many industrial systems.

At least one embodiment of the invention improves the situation.

In particular, one or more embodiments of the invention therefore aims to remedy some or all of the aforementioned shortcomings.

### BRIEF SUMMARY OF THE INVENTION

At least one embodiment of the invention notably proposes a method for constructing a decision tree for diagnosing a system comprising a plurality of components, said method comprising:
obtaining a training data set comprising pairs, one said pair comprising a vector of measured values of observable variables representing an operation of the system and an associated label, the label belonging to a group of labels comprising a label representing a nominal operating state of said system and labels each representing a failure state of said system, each failure state being associated with at least one component of said system,
processing a current node associated with a subset of the training data set, the so-called current data set, derived from the training data set, said processing comprising, when at least one splitting criterion is satisfied, splitting the current node into a first and a second child node by applying a classification function obtained from the current data set and defined to associate with a plurality of said observable variables, a first class, the so-called nominal class, representing the nominal operating state of the system or a second class, the so-called failure class, representing said failure states of said system, and classifying the pairs of the current data subset comprising a first label of the group of labels in the nominal class and the pairs of the data subset comprising a second label of the group of labels in the failure class, and propagating said pairs classified in the nominal class in a first data subset of the first child node and said pairs classified in the failure class in a second data subset of the second child node, and
providing a decision tree for system diagnosis.

At least one embodiment of the invention thus relates to the construction of a decision tree for diagnosing a system comprising several components, by symbolic classification, based on the principles of structural analysis, but without the need to know the variables governing the equations of the system to be diagnosed.

Decision tree construction involves the initial creation of a root node which is split into two child nodes and to each of which one or other of two distinct parts of the data set associated with the root node is propagated. This splitting takes place at root node level, then at child node level, using a classification function specifically defined and adjusted for each level, so as to discriminate, in the part of the training data set associated therewith, pairs comprising labels representing two distinct operating states of the system to be diagnosed. The pairs thus separated are propagated in either of the branches leading to either of the two child nodes of the current node. The process is repeated for each child node as long as a splitting criterion is satisfied.

As each node is dedicated to discriminating between two given labels based on a data set obtained by splitting the training data set of a parent node, discrimination becomes more refined the further down the decision tree you go.

The decision tree thus constructed is a multivariate decision tree since it uses, at a given node, several of the observable variables available as input.

With at least one embodiment of the invention, the classification functions that operate at each node level are obtained from the plurality of observable variables available as input and from the data subset of the training data set associated with the current node.

The unsplit nodes or leaves of the decision tree thus constructed are associated with an operating state of the system (nominal or failure of a component) and therefore each make it possible to isolate a failure state of the various system components.

At least one embodiment of the invention applies to any type of static industrial system comprising m components, with m an integer greater than 2, each of which being able to give rise to a type of failure or fault, that is, it processes observable variables representing an operation of this system, which are static. In other words, it does not process dynamic variables (whose derivative is non-zero).

According to at least one embodiment of the invention, said splitting criterion comprises an impurity criterion and said method comprises checking the impurity criterion, comprising determining a ratio between a number of pairs of the current data set associated with a given label in the group of labels and a total number of pairs of said current data set, the impurity criterion being checked when the ratio is lower than a given purity threshold.

In other words, as long as at least two distinct operating states of the system are represented in the current data set associated with the current node (it is impure), there is an attempt to split the node. If, on the other hand, it is checked that only one operating state is represented in the current data set (the current node is pure), processing stops and the current node will not be split. This is a leaf node which terminates a given branch of the decision tree.

According to at least one embodiment of the invention, processing the current node comprises, when the impurity criterion is satisfied:
selecting the first and second labels in the group of labels, the so-called label pair, the first and second labels being distinct and represented in the pairs of the current data set,
determining a search data set using at least some of the current data set and based on the selected label pair, and
searching for the classification function using symbolic classification based on a given set of operators and the pairs in the search data set.

At least one embodiment of the invention thus proposes the use of symbolic classification to obtain the classification function of a given node. Symbolic classification enables candidate functions to be generated from a given set of operators and available input variables, and tested. It requires no further knowledge of the system.

According to one or more embodiments of the invention, said at least one splitting criterion comprises a classification performance criterion of the classification function obtained, and the method comprises, prior to splitting, verifying said performance criterion, comprising determining a first ratio between a number of pairs of the current data set comprising the label representing a nominal operating state classified by the classification function in the nominal class out of a total number of pairs in the current data set comprising said label, determining a second ratio between a number of pairs in the search data set classified by the classification function in the class from the nominal class and the failure class which corresponds to their label and a total number of pairs in the search data set, and comparing the first and second ratios respectively with a first and a second given threshold, the classification performance criterion being verified when the first and second thresholds are crossed.

The first test verifies that the classification function found correctly classifies the pairs associated with the label representing nominal operation. For example, a first ratio threshold of 95% is considered, which ensures that substantially all the pairs in the current data set, comprising the label representing a nominal operating state, are correctly classified by the classification function. The second test verifies that the classification function correctly classifies the pairs used to search for it. For example, a second minimum ratio threshold set at 90% is used.

When these two tests are successful, the classification function found is considered to form an analytical redundancy relation for the system. Such an analytical redundancy relation is an example of a residual generator, that is, an expression of variables, herein observable variables of the system to be diagnosed which the classification function takes as input, which produces zero (the nominal class) for nominal cases and a non-zero value (the failure class) for all other cases. The failure cases that it discriminates by classifying them in the failure class constitute its support for failures or faults. According to the invention, a classification function was sought which in particular produces a non-zero value for pairs comprising the second label. It is understood that it can produce a non-zero value for other labels in the group of labels than the second label, with the exception of the first.

According to at least one embodiment of the invention, after splitting the current node and as long as at least one next node remains unprocessed according to a given sequence of the decision tree, the method comprises iterating the processing for the next node.

In this way, it is attempted to split all the nodes of the tree that can be split.

According to one or more embodiments of the invention, when the classification performance criterion has not been checked, the processing of the current node comprises selecting a new pair of labels provided that there remains one pair of labels not yet selected in the current data set.

In this way, symbolic classification is performed on all possible label pairs as long as there are still some to be tested in the current data set and that no classification function has been found that performs an ARR on the system for the selected label pair.

According to at least one embodiment of the invention, when the current data set includes pairs comprising the label representing a nominal operating state, the selected label pair comprises said label as a first label and a label representing a fault state as a second label.

As long as the nominal case is represented in the current subset, the focus is on discriminating between the nominal case and a failure type itself also represented in the current data set.

According to one or more embodiments of the invention, the search data set comprises all the pairs in the current data set comprising the label, among the first and second labels, which is the least represented in number in the current data set, and as many pairs in the current data set comprising the other label.

This balances the search data set and increases the chances of obtaining a sufficiently efficient classification function.

According to at least one embodiment of the invention, when the current data set does not include any pairs comprising the label representing a nominal operating state, the current data set comprising a first number of pairs comprising the first label and a second number of pairs comprising the second label, said first number being greater than the second number, the search data set is formed of a third number of pairs comprising the first label, less than or equal to the second number, the second number of pairs and a fourth number of pairs comprising the label representing a nominal operating state of the system, the fourth number being equal to a difference between the second and third numbers.

In this case, the selected label pair comprises two labels representing a failure state.

Adding these pairs comprising the nominal operating label to the search data set associated with the pair (failure 1, failure 2) enables symbolic classification to be implemented using a balanced search data set, and a classification function to be found which performs an ARR that produces 0 (the nominal class) for pairs comprising the “failure 2” label or the label representing a nominal operating state and a value other than zero (the failure class) for pairs comprising the “failure 1” label. In other words, an ARR is sought that is “sensitive” (at least) to failure 1, but is not sensitive to failure 2 or, of course, to the nominal operating state.

For example, the pairs comprising the label representing a nominal operating state are taken from the initial training data set and chosen at random. For example, they are stored in a memory so as to be available for balancing tree node search data sets as they are processed.

For example, a number of pairs is kept comprising the first label which is selected to be equal to half the second number of pairs comprising the second label and which is supplemented with a number of pairs comprising the label representing a nominal operating state also equal to half the number of pairs comprising the second label. One advantage is to balance the search set.

It is understood that herein the pair of failure labels is ordered and that the search data set associated with this pair (failure 1, failure 2) and used to search for an ARR classification function, is not determined in the same way as that associated with the pair (failure 2, failure 1).

It is also understood that it is advantageous to generate and test all possible permutations of label pairs from the current subset since they are not based on the same search data set.

According to at least one embodiment of the invention, searching for a classification function by symbolic classification comprises implementing a genetic algorithm comprising:
randomly generating a plurality of candidate functions (c) associating an actual classification value with several of said observable variables,
For each candidate function generated, evaluating the candidate function comprising applying said candidate function to the search data set, for the actual classification values obtained, and applying a transformation function to said actual classification values, with binary transformed values being obtained and determining a fitness score(S) for the candidate function of the search data set from said binary transformed values,
selecting at least one candidate function from the plurality of candidate functions generated using the fitness score, said at least one generated candidate function being associated with said at least one best fitness score according to a given criterion,
mutating the at least one selected candidate function and iterating the test and selection steps on the mutated functions, until at least one stopping criterion is not satisfied.

One advantage of the transformation function used is that it produces transformed values taking its values directly from the set {0,1}, unlike the prior art which generally uses a sigmoid function, whose values lie between 0 and 1, but remain real. This makes it possible to obtain values comparable to the nominal class and the failure class, and therefore used directly in the construction of the decision tree.

For example, the transformation function is a so-called well function, which is zero around zero and one everywhere else in the set of real values. One advantage of this function is its simplicity.

According to at least one embodiment of the invention, said at least one stopping criterion comprises at least:
determining a stagnation of the fitness score during a given number of iterations, and
a maximum number of iterations of the evaluation and selection steps is reached,

For example, the given number of iterations is equal to 4 and the maximum number of iterations is selected to be equal to 50. One advantage of such stopping conditions is that they enable a good compromise between efficiency and cost in terms of computing and memory resources.

Correspondingly, at least one embodiment of the invention also relates to a method of diagnosing a system comprising a plurality of components, said method comprising:
obtaining values measured by sensors of observable variables representing an operation of said system, an input vector comprising the measured values of said observable variables being formed;
applying to said vector a decision tree constructed by the aforementioned method from a set of training data comprising vectors of observable variables in the same format as the input vector, said application comprising propagating the input vector in the decision tree up to an unsplit node, the so-called leaf node, said leaf node being associated with at least one label belonging to a group comprising a label representing a nominal operating state of the system and a plurality of labels each representing a failure state of the system, and
providing a diagnosis result, comprising said at least one label associated with the leaf node comprising said vector.

One or more embodiments of the invention enables precise diagnosis of the operating status of the system which isolates failures and indicates, in the event of a failure, which components are impacted. To achieve this, it suffices to read the label(s) associated with the leaf node where the input vector ended up. It (they) represent(s) the operating state of the system corresponding to the measured values of the observable variables of the input vector.

At least one embodiment of the invention also relates to a device for constructing a decision tree for diagnosing a system comprising a plurality of components, said device comprising at least a memory and a processor configured to implement:
obtaining a training data set comprising pairs, one said pair comprising a vector of measured values of observable variables representing an operation of the system and an associated label, the label belonging to a group of labels comprising a label representing a nominal operating state of said system and labels each representing a failure state of one said component of the plurality,
processing a current node associated with a subset of the training data set, the so-called current data set, derived from the training data set, said processing comprising, when at least one splitting criterion is satisfied, splitting the current node into a first and a second child node by applying a classification function obtained from the current data set and defined to associate with a plurality of said observable variables, a first class, the so-called nominal class, representing the nominal operating state of the system or a second class, the so-called failure class, representing said failure states of said system, and classifying the pairs of the current data subset comprising a first label of the group of labels in the nominal class and the pairs of the data subset comprising a second label of the group of labels in the failure class, and propagating said pairs classified in the nominal class in a first data subset of the first child node and said pairs classified in the failure class in a second data subset of the second child node, and
providing a decision tree for system diagnosis.

The decision tree thus constructed is for example stored in the memory of the device. Alternatively, it may be transmitted to a remote device via a communications network. Advantageously, such a device implements the aforementioned construction method in its various embodiments.

At least one embodiment of the invention also relates to a device for diagnosing a system comprising a plurality of components, said device comprising a memory and a processor configured to implement:
applying to said vector a decision tree constructed by the aforementioned method for constructing a decision tree from a set of training data comprising vectors of observable variables in the same format as the input vector, said application comprising propagating the input vector in the decision tree up to an unsplit node, the so-called leaf node, said leaf node being associated with one label belonging to a group comprising a label representing a nominal operating state of the system and a plurality of labels each representing a failure state of one said component of the system,
obtaining the label associated with the leaf node of the decision tree comprising said vector, and
providing a diagnosis result, comprising the label obtained.

For example, this device comprises a memory which stores the decision tree and the diagnosis result. The diagnosis result can also be transmitted to remote equipment via a communications network.

According to at least one embodiment of the invention, this device is integrated into a terminal equipment.

One or more embodiments of the invention also relates to a computer program product comprising instructions for executing one of the aforementioned methods.

Finally, at least one embodiment of the invention relates to a computer-readable recording medium on which the aforementioned computer programs are recorded.

Of course, the one or more embodiments described above can be combined with one another.

### BRIEF DESCRIPTION OF THE DRAWINGS

Other features and advantages of the one or more embodiments of the invention will become apparent upon reading the detailed description below, and the annexed drawings, wherein:

FIG. 1a schematically shows an example of the use of devices according to one or more embodiments of the invention in their environment,

FIG. 1b schematically shows a simplified example of a system comprising several components, known as a “polybox”, according to one or more embodiments of the invention,

FIG. 2 schematically shows, in the form of a flow chart, the steps of a method for constructing a decision tree for diagnosing a system comprising a plurality of components according to one or more embodiments of the invention,

FIG. 3a schematically shows an example of a binary decision tree comprising a root node, intermediate nodes and leaf nodes, according to one or more embodiments of the invention,

FIG. 3b schematically shows an example of a training data set comprising training data associated with different labels representing a system operating state, according to one or more embodiments of the invention,

FIG. 3c shows, in table form, an example of the distribution of training data between the nodes of a decision tree constructed by the method according to one or more embodiments of the invention,

FIG. 4a schematically shows examples of candidate functions generated by symbolic classification from observable variables of the system and a given set of operators, according to the prior art,

FIG. 4b details the steps of a genetic algorithm for generating and evaluating candidate functions for diagnosing training data using symbolic classification, according to one or more embodiments of the invention,

FIG. 4c schematically shows an example of a function for transforming an image of a candidate function into one of a first class and a second class, according to one or more embodiments of the invention,

FIG. 5a and FIG. 5b schematically show examples of a current node split into two child nodes, by applying the analytical redundancy relation determined for this current node, according to one or more embodiments of the invention,

FIG. 5c schematically shows an example of a decision tree constructed by the method according to one or more embodiments of the invention and details the analytical redundancy relations associated with the split nodes,

FIG. 6 schematically shows, in the form of a flow chart, the steps of a method for diagnosing a system comprising a plurality of components according to one or more embodiments of the invention,

FIG. 7 schematically shows an example of the hardware structure of a device implementing one or other of the methods according to one or more embodiments of the invention, and

FIG. 8 schematically shows a concrete example of an industrial system, according to one or more embodiments of the invention.

### DETAILED DESCRIPTION OF THE INVENTION

At least one embodiment of the invention relates to diagnosing an industrial system comprising several components whose operation may be nominal or faulty. In the event of a malfunction, one or more of the system components may be at fault.

At least one embodiment of the invention is based on the construction of a binary decision tree by symbolic classification using the principles of structural analysis in order to determine analytical redundancy relations between observable system variables and to isolate types of failure or fault each affecting one or more system components. A given analytical redundancy relation is associated with a given set of failures, also known as fault support, and with a current node of the decision tree. Upon receipt of a vector of observable system variables, received from the top level of the decision tree, the current node applies this analytical redundancy relation thereto in order to decide whether it should be propagated to one or other of these lower-level child nodes. The leaf nodes, that is, the unsplit nodes of the decision tree, each diagnose one of the operating states of the system (the nominal operating state and the various types of failure that the system may encounter).

The decision tree thus constructed is a multivariate binary tree, in the sense that in a given node, it discriminates using a criterion that makes use of several observable system variables (as opposed to a node of a univariate tree which only uses a single variable). It can then be used to detect and isolate one of the given failure types from a data vector of measured observable variables.

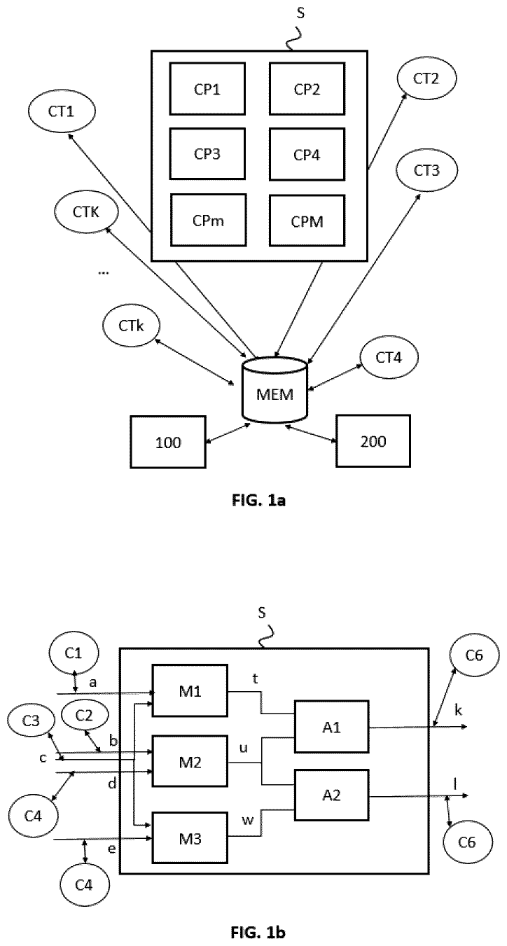

In relation to FIG. 1a, an implementation example of one or more embodiments of the invention is considered for an industrial system S, comprising several components CP1, CP2, CPm, . . . , CPM, with M an integer greater than or equal to 2, and for which a plurality N of observable variables vo1, vo2, . . . , voN are observed, with N an integer greater than or equal to 2, representing an operation of at least one said component and for which the values are measured, for example, by K sensors CT1, CT2, . . . , CTK, with K an integer greater than or equal to 2, arranged in proximity to the M components of the system S. For example, said variables comprise at least the inputs and outputs of the components of said system. They can further comprise any other parameter indicative of an operating state of the system at one of its components, such as temperature, pressure, fluid volume, etc.

The measurement data collected by the sensors is for example stored in a memory MEM or transmitted to a collection device (not shown) via communication means. In this example, at least one embodiment of the invention is implemented by a device 100 for constructing a binary decision tree. This device 100 is configured to obtain a set of training data comprising pairs, one said pair comprising a vector of values of observable variables and a label (f(x1, x2, . . . , xM)) associated with said vector, the label belonging to a group of labels comprising a label representing a nominal operating state of the system and a plurality of labels each representing a type of failure of a system component, to construct a decision tree and make the decision tree available for system diagnosis. For example, the decision tree thus constructed is stored in the memory MEM.

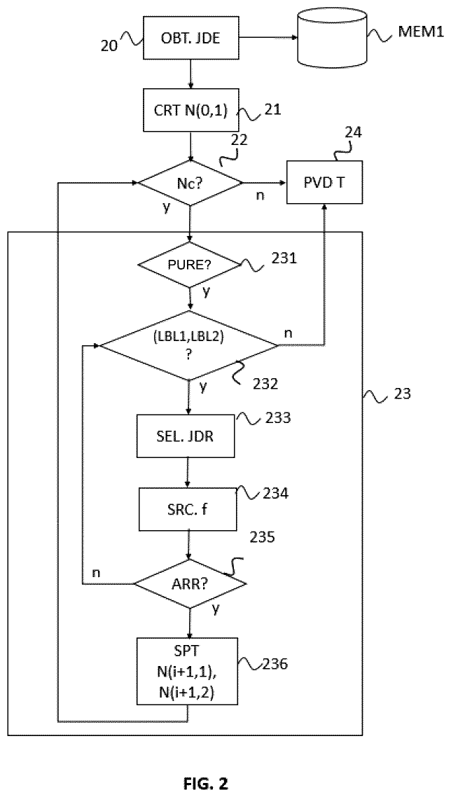

As shown in FIG. 1a, the device 100 is configured to implement a method for constructing a decision tree for diagnosing a system comprising several components, according to one or more embodiments, which will be detailed below, in relation to FIG. 2.

This example also considers a device 200 for diagnosing the system S comprising several components, configured to obtain values measured by the sensors of observable variables and to form an input vector having the same format as the vectors of the pairs of the training data set used to construct the decision tree, to apply the decision tree obtained by the device 100 to said vector, to obtain the label associated with the leaf node of the decision tree associated with said vector, and to make available a diagnosis result comprising the label obtained.

For example, the device 200 obtains the decision tree constructed by the device 100 from the memory MEM and it stores the diagnosis result in this same memory. Alternatively, it transmits the diagnosis result to remote equipment or to a user via a user interface.

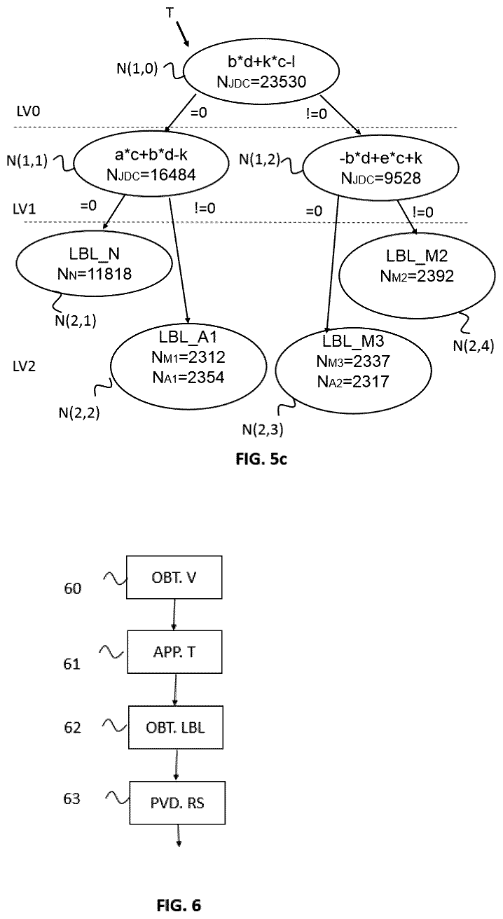

An example of the hardware structure of devices 100 and 200 will be described in relation to FIG. 7, according to one or more embodiments of the invention.

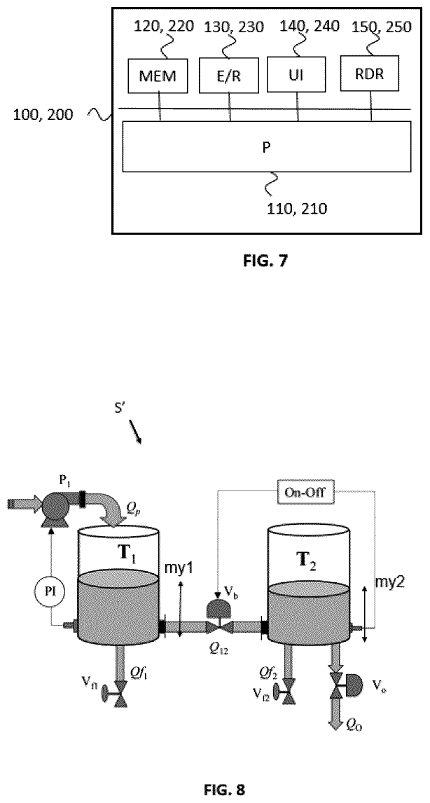

At least one embodiment of the invention applies to diagnosing any type of complex industrial system whose observable variables are static. It can be used to detect and isolate a faulty operating state of one of its components. For example, it may be desirable to maintain an output flow rate of a water reservoir at a given value, or diagnose the state of disrepair of a building or even diagnose the print quality of a 3D printer. Examples will be described in more detail below, in relation to FIGS. 1b and 8, according to one or more embodiments of the invention.

In relation to FIG. 1b, according to one or more embodiments of the invention, an example of a simplified system S, a so-called polybox, is first considered for illustrative purposes. This “polybox” system comprises M=5 components M1, M2, M3, A1 and A2. The observable variables considered are inputs a, b, c, d and e, intermediate inputs/outputs t, u and w, and outputs k and I. The component M1 has inputs a and c, the component M2 has inputs b and d, the component M3 has inputs c and e. The component A1 has inputs t and u and output k, and the component A2 has inputs u and w and output I. In this simple example, the components M1, M2, M3 are multipliers, multiplying the input data between themselves and producing the result of this multiplication at the output and the components A1, A2 are adders, adding the input data and producing the result of this sum at the output. The “polybox” system is representative of the industrial systems that can be handled by the at least one embodiment of the invention, since each of its components can represent any component of a system. It is assumed herein that several faults or failures can occur at the same time. However, it is noted that the polybox is a static system which is therefore not representative of dynamic systems.

In relation to FIG. 2, the steps of the method for constructing a binary decision tree are now described according to one or more embodiments of the invention. For example, this method is implemented by the device 100.

In 20, a training data set JDE is obtained. It comprises pairs associating with a vector of observable variables representing the operation of the system S, a label representing an operating state of this system from a plurality of labels (M+1) comprising a label representing a nominal operating state of the system and M labels representing types of failure of the M components of the system. For example, this data set JDE is stored in a memory MEM1 accessible to the device 100.

For example, for the “polybox” system shown in FIG. 1b, there are 6 labels; a label corresponding to nominal operation LBL_N, a label corresponding to a failure LBL_M1 of the component M1, a label corresponding to a failure LBL_M2 of the component M2, a label corresponding to a failure LBL_M3 of the component M3, a label corresponding to a failure LBL_A1 of the component A1 and a label corresponding to a failure LBL_A2 of the component A2. The training data set JDE comprises a plurality of vectors of K observable variables V (a, b, c, d, e, k, I) with K greater than or equal to 2, each vector being associated with one of the foregoing labels. Note that in the example shown in FIG. 1b, K is 7 and the variables t, u and w were not observed. For example, the values of observable variables constituting the vector V are measured by K sensors arranged in and/or near the components of the system S. For example, 30000 pairs (vector, label) have been obtained which are separated into a training data set JDE comprising 23350 pairs and a test set JDT comprising 6650 pairs.

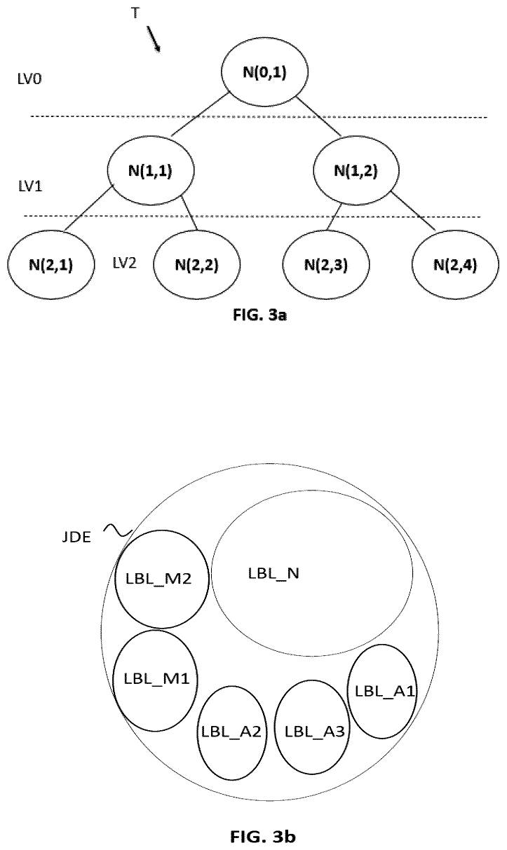

According to at least one embodiment of the invention, a binary decision tree T is constructed from the training data set JDE obtained, using a top-down, or in other words, root-to-leaf approach. An example of a decision tree T is shown in FIG. 3a. In this example, it comprises a root node N(0,1) at a first level LV0, two child nodes N(1,1) and N(1,2) of the root node at a second level LV1 and, at a third level LV2 two child nodes N(2,1) and N(2,2) of the child node N(1,1) and two child nodes N(2,3) and N(2,4) of the child node N(1,2).

In 21, the root node N(0,1) is created, wherein all the pairs in the training data set JDE are propagated. An example of a training set JDE is shown in FIG. 3b. It comprises a subset of pairs comprising nominal operating label LBL_N, a subset of pairs SJ_M1 comprising failure label LBL_M1 of component M1, a subset SJ_M2 of pairs comprising failure label LBL_M2 of component M2, a subset of pairs SJ-M3 comprising failure label LBL_M3 of component M3, a subset of pairs SJ_A1 comprising failure label LBL_A1 of component A1 and a subset of pairs SJ-A2 comprising failure label LBL_A2 of component A2. For example, the training data set JDE comprises 23530 pairs which are divided into the foregoing subsets as shown in the first row of the table in FIG. 3c. In this example, of subsets SJ_M1, SJ_M2, SJ_M3, SJ_A1 and SJ_A2, subset SJ_M2 is the most populated.

In 22, a current node Nc is selected for processing according to a given sequence order of nodes already created in the tree T. At initialization, only root node N(0,1) exists, therefore it is selected as the current node.

In 23, the current node Nc is processed. It is associated with a current data set JDC. In this first iteration, root node N(0, 1) and the initial training data set JDE are related, but the processing that will be described applies equally to all successively processed current nodes.

In 231, it is tested whether the current node Nc can be split. A first splitting criterion is verified herein, which is in fact a node purity criterion and is assessed with regard to the composition of the current data set.

In at least one embodiment of the invention, the following purity test is performed:
the label most represented in number in the current data set JDC and a ratio of a number of pairs in the current data set associated with this label are determined,
the ratio obtained is compared with a given purity threshold. For example, a node is considered pure if the ratio is at least Y % with Y=95. Of course, this is one parameter of the algorithm, which can take on other values based on the problem to be solved.

If the result is negative, that is, the current node is impure, it is decided that it can be split and we move on to the next step 232. Otherwise (the current node is pure), we return to step 22 to select another current node.

Note that the purity test is also applied to the root node to cover the case where the training data set contains an overwhelming majority of pairs associated with a single label.

In 232, a pair of labels (LBL1, LBL2) represented in the pairs of the current data set JDC is selected.

According to at least one embodiment, label LBL_N representing a nominal operating state of the system is favored, that is that if it is represented in the current data set, it is selected as the first label and a label representing a type of system failure, itself also represented in the current data set JDC, is selected as the second label. For example, the most represented failure label is selected in the current data set.

In the example of FIG. 3c, for the root node N(0,1), label LBL_N is selected representing nominal operation of the system S. This happens to be the most represented in terms of number of pairs in the training data set (11818 pairs). Label LBL_M2 is selected as a second label representing a failure of component M2 which is the most represented after label LBL-N with 2392 pairs. The pair of labels (LBL_N, LBL_M2) is therefore obtained.

In 233, a search data set JDR is determined, based on the selected pair of labels and the current data set. For example, the search data set JDR is constructed so that it comprises as many pairs in the current data set associated with label LBL_N as there are pairs associated with failure label LBL-M2. A search data set JDR is therefore obtained comprising 2392 pairs comprising label LBL_N and 2392 pairs comprising label LBL_M2.

In 234, a classification function is sought whose variables x are at least some of the observable variables of the pairs in the search data set JDR and whose image f(x) is a first class CL1 for the vectors of the pairs comprising label LBL_N and a second class CL2 for the vectors of the pairs with label LBL M2.

According to at least one embodiment of the invention, this classification function is sought using the principles of a so-called symbolic classification method, which will now be explained.

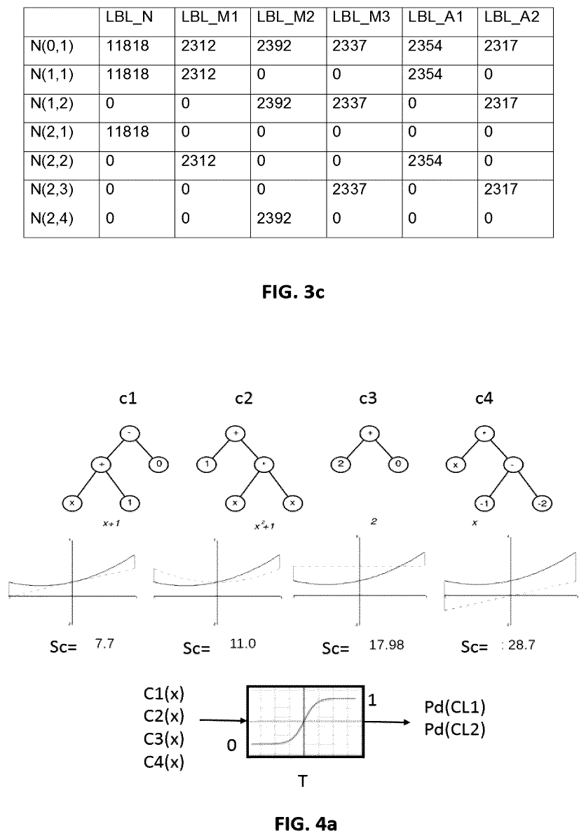

Symbolic regression is a method of estimating a function f allowing output data to be obtained from input data, knowing pairs (x, f(x)) with x=(x1, x2, . . . , xn)∈Rⁿ and f(x)∈R. This is a kind of regression that makes no assumptions about the form of the solution. Only a list of usable operators is specified, such as addition (+), subtraction (−), multiplication (x), division (/), cosine (cos), sine (sin), exponential (exp), root (√), logarithm (log), natural logarithm (ln) operators and so on. From these operators and input data x, candidate functions are generated, as shown in FIG. 4a, which are then evaluated.

This method is designed to produce a precise analytical solution. To that end, it is based on a genetic algorithm, an example of which will be presented below in relation to FIG. 4b, according to one or more embodiments of the invention.

In a manner which is per se known and for example described in the book by Poly et al., entitled “A field guide to genetic programming”, chapter 4, published ir 2008 by Lulu Press (lulu.com), https://libros.metabiblioteca.org/items/22e518bc-10f3-4568-af42-aca90b8320d1, such a genetic algorithm takes as input a set of pairs known in advance (x, f(x)) and a set of operators O and searches for the best combination Cx, O of variables (x1, x2, . . . , xn) and operators so that, Cx, O=f (x).

With each generation, each candidate c solution is evaluated on the entire data of the search data set and receives a fitness score, which represents a degree of adequacy of the solution c with the function f, as shown in FIG. 4a. Under each candidate function c1 to c4, the curves with solid lines represent the objective function in black (f as a function of x, which is therefore the same on all curves) and those with dotted lines represent the candidate function c1 to C4. The fitness score indicates whether the candidate function is close to or far from the objective.

This score is determined for example using the following formula:

$$Sc ( c ) = 1 / n {\sum }_{x ∈ JDR} {( f ( x ) - c ( x ) )}^{2} \qquad ( Equation 1 )$$

where n is the number of pairs in the data set (that is, the number of pairs (x, f (x))

Symbolic classification is a binary classification method for estimating a function f (from Rⁿ into R) knowing pairs (x, label) with x=(x1, x2, . . . , xn)∈Rⁿ and label∈{0, 1}. Like symbolic regression, it makes no assumptions about the form of the solution and provides a precise analytical solution itself also obtained using a genetic algorithm. As with symbolic regression, the genetic algorithm takes as input a set of pairs (x, label) and a set of operators O (for example +, *, −, /, √, ∥, log, etc.). It also searches for the best combination Cx, O of variables (x1, x2, . . . , xn) and operators so that Cx, O=f(x). Symbolic classification is therefore similar to symbolic regression, except for the following two aspects:
the set of label values belongs to {0, 1}, rather than to the set of actual values, and
the fitness score is calculated differently.

Indeed, the candidate functions, when applied to, give a number in R.

Symbolic classification therefore comprises an additional step in relation to symbolic regression, which consists in applying a transformation function T to the image y=c (x)∈R of a candidate function c and which produces an image T(y)∈[0, 1]. This transformation function T can take several forms. For example, it could be a sigmoid function, as shown in figure FIG. 4a. Then, if the value of T(y) is less than 0.5, class 0 is associated with x and otherwise class 1 is associated with x.

For example, the fitness score Sc implements a logarithmic loss function, as described in the book by Bishop et al., entitled “Pattern Recognition and Machine Learning”, published by Springer, in 2006, page 209, according to the following formula:

$$Sc ( c ) = \qquad ( Equation 2 )$$

$$- 1 / n \sum {x}_{∈ JDR} label * ln ( T ( c ( x ) ) ) + {( 1 - label * ln ( 1 - T [ c ( x ) ) )}^{}$$

where n is the number of individuals in the search data set (that is, the number of pairs (, label)) and T is the chosen transformation function.

According to at least one embodiment of the invention shown in FIG. 4b, the step 234 of searching for a function f associated with the current node comprises the following sub-steps:
randomly generating 2340 a plurality of candidate functions c, from a given set of operators. A simple illustrative example is shown in FIG. 4a. In this example, 4 candidate functions c1, c2, c3 and c4 are generated from the + operator for c1, the + and x operators for c2, + for c3 and * and − for c4. Note that not all available operators will necessarily be used to generate the candidate functions. On the other hand, if certain operators are missing, some potentially useful candidate functions cannot be generated or evaluated. It may therefore be useful to include more operators than necessary in the set O.
for each candidate function c generated, evaluating 2341 the candidate function involves applying the candidate function to the search data set and determining the fitness score Sc for this search data set, as previously described. In relation to FIG. 4a, the candidate functions are applied to the search data set JDR. Their images c1(x), c2(x), c3(x) and c4(x) which take their values in R are transformed by the transformation function T which according to at least one embodiment of the invention directly provides a transformed result belonging to {0,1}. For example, the transformation function T selected is the well function Pt as shown in FIG. 4c. One advantage of this well function is that it allows a result to be obtained directly and simply in {0, 1}, that is, in the first class CL1 and the second class CL2 {CL1, CL2} respectively.
selecting 2342 at least one best candidate function C from the plurality of candidate functions c generated using the fitness score, said at least one generated candidate function C being associated with said at least one best fitness score according to a given criterion, and
Mutating 2343 the at least one selected candidate function C, with one or more mutated candidate functions Cm being obtained.

According to at least one embodiment of the invention, this succession of sub-steps is iterated for the mutated candidate functions Cm, as long as at least one stopping criterion is not met in 2134.

According to at least one embodiment of the invention, the following stopping criteria are applied:
the fitness score Sc is constant for a given number of iterations, for example equal to 4,
a maximum number of iterations of steps 2341 to 2343 have already been performed,

One advantage is to achieve a good compromise between cost and efficiency.

At the end of this step 234, a second splitting criterion of the current node is checked. This is a classification performance criterion for the classification function f produced by the search step 234.

To do this, the following test is performed in 235:
it is checked that the classification function f found correctly classifies the pairs in the search data set JDR on which it was searched. For example, this condition is considered satisfied when 90% of the pairs are correctly classified (pairs with label LBL_N in class CL1 and the others in class CL2),
the classification function f is applied to the current data set JDC and it is checked that it correctly classifies the pairs comprising label LBL_N. For example, this second condition is considered satisfied when 95% of the pairs comprising label LBL_N are classified in nominal class CL1.

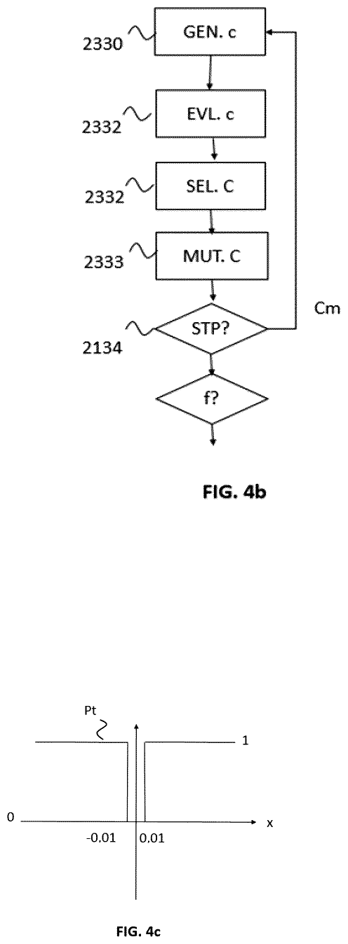

If the classification performance test is successful, the classification function f is considered to constitute an analytical redundancy relation allowing the failure type corresponding to the second label LBL_M2 to be discriminated from other failure types. It is also said that the current node is associated with a failure indicator of component M2. According to the illustrative example in FIG. 5a, the test is indeed successful and the ARR obtained for node N(0,1) is as follows: b*d+e*c−l.

If, on the other hand, one of the two conditions is not satisfied, then the classification function f found is not considered sufficiently effective to perform an ARR. In this case, we return to step 232 to select a new pair of labels. It is checked whether there are any pairs of labels represented in the current data set JDC that have not yet been tested.

In this respect, it should be noted that according to at least one embodiment of the invention, a distinction is made between the case where label LBL_N is represented in the current data set and the case where it is no longer represented. The latter case will be detailed below in relation to the processing of node N(2,2).

In 236, the current node N(1,1) is split by applying the classification function f to the pairs in the current data set JDC and two data subsets are obtained:
a first subset SJ11 comprising all the pairs to which the classification function f associates nominal class CL1. On the basis of the previous performance test, it is known that it essentially comprises all the pairs in the current data set JDC which comprise nominal operation label LBL_N, but it may comprise others thereof. In other words, this is all the pairs in the training data set JDE comprising a failure label to which the ARR f found for node N(0,1) is not sensitive. As shown in FIG. 5a, these are pairs comprising label LBL_A1 or LBL M1.
a second subset SJ12 comprises all the pairs classified by the classification function f in failure class CL2. From the previous performance test, it is known that it essentially includes all the pairs in the search set JDR comprising the second label LBL_M2, but it may also include pairs associated with one or more other failure labels. In this case, the ARR f is said to be sensitive to labels other than the one corresponding to the indicator of the current node. In other words, the current node Nc cannot isolate a given fault. In the example shown in FIG. 5a, for the root node, these are pairs comprising labels LBL_M2, LBL_M3 or LBL A2.

Two child nodes N(1,1) and N(1,2) of current node Nc are created, at a lower level to that of current node Nc, as shown in FIG. 3a (LV1) and respectively propagate the first data subset SJ11 to the first child node N(1,1) and the second data subset SJ12 to the second child node N(1,2).

As processing of the current node Nc is complete, we return to step 22 to select a new current node Nc. This is the next node from the nodes already created in the decision tree T and not yet processed, according to a given sequence of the tree. For example, the tree is traversed from top to bottom, and for a given level, from left to right. In the example in FIG. 3a, root node N(0,1) has just finished processing at level LV0; we go down to level LV1 and select the first child node N(1,1).

In 23, child node N(1,1) is processed as described above for root node N(0,1). It is associated with the current data set JDC, which corresponds to data subset SJ11.

In 231, it is verified that it is not pure. In the present case, this is indeed the case since the current data set JDC of the current node N(1,1) comprises the 11818 pairs comprising nominal operation label LBL_N, but also 2312 pairs comprising failure label LBL_M1 and 2354 pairs comprising label LBL_A1.

In 232, a pair of labels is selected. Once again, label LBL_N is represented in the current data set. In this example, the pair of labels (LBL_N,LBL_M1) is selected.

In 233, an adapted search data set JDR is constructed. For example, it is formed of 2312 pairs comprising label LBL_M1 and 2312 pairs comprising label LBL_N, as previously described.

In 234, a classification function f is sought from the search set JDR thus obtained.

In 235, the classification performance test is performed and it is checked that the classification function f found is indeed an ARR. In the example shown in FIG. 5b, the ARR f is: a*c+b*d−k.

In 236, current node N(1,1) is split into two child nodes N(2,1) and N(2,2) and the data subsets obtained by applying the classification function f as previously described for root node N(0, 1) are propagated thereto. The pairs in the current data set JDC comprising a label to which the function f is sensitive (LBL_M1 and LBL_A1) are propagated to the second child node N(2,2) while the others (LBL_N) are propagated to the first child node N(2,1).

This continues for as long as there are nodes to be processed. In this case, node N(1,2) is processed, followed by nodes N(2,1) to N(2,4).

For nodes N(2,1) and N(2,4), it is noted, as shown in the table in FIG. 3C, that they are pure, since all the pairs in their data set comprise the same label (LBL_N for node N(2,1) and LBL_M2 for node N(2,4). Neither of them passes test 231, therefore they are not split. In other words, these are leaf nodes which each diagnose the label present in their associated data set.

Nodes N(2,2) and N(2,3) are not pure. Steps 232-236 are therefore applied thereto.

For node N(2,2), two separate labels are represented in the dataset thereof, but they are both failure labels (LBL_A1 and LBL_M1).

According to at least one embodiment of the invention, the pair of labels (LBL_A1, LBL_M1) is selected in 232 and the search data set JDR is constructed as follows:
The label with the highest number of representations in the current data set of the current node is determined. In this case, data set SJ22 associated with node N(2,2) comprises 2312 pairs comprising label LBL_M1 and 2354 pairs comprising label LBL_A1, as shown in the 5th row of the table in FIG. 3c,
A first subset of pairs comprising label LBL_A1 is selected, for example at random. For example, this first subset comprises 2312/2 pairs, namely half the number of pairs associated with label LBL_M1. Furthermore, a second subset comprising as many (namely 2312/2 pairs) comprising label LBL_N is obtained, for example in a memory, such as memory MEM1. Finally, the search set JDR is formed by combining the first subset, the second subset and the 2312 pairs comprising the second label LBL_M1.

One advantage of adding pairs comprising label LBL_N is that it makes it possible to search for an ARR that is sensitive to the failure of component A1, but is not sensitive to that of component M1, nor to the nominal operating state.

It is understood that herein the pair of failure labels selected in 232 is ordered and that the search data set associated with this pair (LBL_A1, LBL_M1) to be used to search for an ARR classification function, is not determined in 233 in the same way as that associated with pair (LBL_M1, LBL_A1). This means testing all possible permutations of the failure labels present in the current data set, namely for a non-zero integer number L of distinct failure labels, L*(L−1) label pairs.

In 234, a classification function f is sought, but it does not pass the classification performance test in 235. The sequence of steps 232-235 is repeated by permutating labels LBL_A1 and LBL_M1 (therefore on pair (LBL_M1, LBL_A1)), but the resulting classification function does not pass the test either.

As there are no more pairs of labels to test, processing stops for node N(2,2) which will therefore not be split. It is a leaf node that is associated with the failure types corresponding to labels LBL_A1 and LBL_M1 which it cannot discriminate between.

The same sequence of steps applies to node N(2,3), which will also not be split even though it is not pure. It is a leaf node that is associated with the failure types corresponding to labels LBL_M3 and LBL_A2 which it cannot discriminate between. According to at least one embodiment of the invention, this node N(2,3) is associated with the most represented label in its current data set. In this way, it is indicated that this leaf node performs the diagnosis of the operating state corresponding to this label. In this example, it is label LBL_M3 that represents the failure state of component M3.

Once all nodes have been processed, construction of the decision tree T is complete. It is made available in 24. For example, it is stored in a memory and/or transmitted to remote equipment via communication means.

According to at least one embodiment of the invention, the method for constructing a decision tree for diagnosing a system comprising several components is implemented in algorithmic form. It is based for example on a python package such as the one documented in the document available at https://gplearn.readthedocs.io/en/stable/intro.html. In particular, such a package can be used to implement a symbolic regression algorithm, which can be configured using parameters, relating for example to a mutation frequency of candidate functions, or a likelihood of each type of permitted mutation, a number of candidate functions generated at each iteration, the fitness score and stopping conditions.

Reference is now made to an example of “pseudocode” for such an algorithm of the decision tree construction method according to at least one embodiment of the invention, provided in the appendix.

In this appendix, the arrow with a plus symbol (←+) means that the value is attached to the variable. All the keywords used are explained below: EMPTY: characterizes a list containing no elements.

PURE: means that at least X % of the data (pairs) present in a given node are of the same class. The value of X is a parameter of the algorithm. The default value is 95%. “PURE with label” means that the node in question only contains pairs comprising the same label.

LEAF: designates a node that has no children, that is that has not been split. When using the constructed decision tree as a decision tool for diagnosis, the data of the data vector that reaches such a leaf node will be predicted or diagnosed as representing the operating state of the system corresponding to the label of this node (denoted node.label in the pseudocode).

GENERATE: applies to a node that is not pure. Thus, the aim is to find a new ARR that splits the data present in this node. Since symbolic classification can only classify between two classes, the ARR is searched using a search data set comprising (vector, label) pairs, representing the types of failure we want this node to discriminate.

A distinction is made between two cases:
1. If the pairs that were propagated up to this node still comprise a representative amount of labels representing a nominal state, the search data set is constructed, as previously described in relation to FIG. 2, with all the pairs comprising the nominal state label (representing nominal class CL1) and pairs comprising any of the failure class labels present in representative quantity at the node (representing failure class CL2). For example, a class label is considered to be present in a representative quantity, or represented, when the current data set comprises Z % of a total number of pairs comprising this label in the initial training data set JDE with Z equal to at least 5 by default.
2. If no pair comprising the label representing nominal operation is present (or present in a representative manner), the failure label(s) that are present in a representative manner are determined. Next, all permutations of pairs of these failure labels are performed. This means that for L pairs of labels comprising a failure label, L (L−1) pairs intended to constitute the search data set for the current node is obtained. This also means that if the (fault a, fault b) pair is present, the (fault b, fault a) pair will also be present. This is important for the following reason: the first class of the pair is then modified for example so that when balancing the pairs (see BALANCE above), half of the data in the first class consists of pairs of the class itself, while half of the pairs in the second class consist of pairs of the class itself, and the other half consists of pairs associated with the nominal class (randomly selected from the data set initially propagated in the node). This allows the symbolic classification method to find an expression that is 0 for pairs associated with the nominal class and not 0 for pairs associated with the first class. In other words, the objective is to find an ARR equation or expression that is sensitive to the second class CL2 but not to the first CL1.
FoundExpression: Found Expression includes the result of executing a symbolic classification function of the package, therefore a function f.
CHECK: means that foundExpression is tested to check whether or not it is an ARR. In other words, CHECK performs the classification performance test described above. To do this, it is necessary to satisfy the two conditions set out above. If one of these is not verified, foundExpression is not considered a valid ARR and the “while” loop continues.
REMAINS: checks that all the pairs of labels have not been tested. If this is the case, the While loop is exited and foundExpression does not exist. As the current node has no associated ARR, it will not be split.
BALANCE: this is a pre-processing step that checks which label is the least represented among the (vector, label) pairs present in the current data set of the node and randomly selects as many pairs from the most represented class. This operation is carried out in such a way that the search for a classification function by symbolic classification of the next row is carried out based on a balanced data set.
EXISTS: if the “while” loop is exited because a foundExpression CHECK test has been legitimately passed, then foundExpression exists. An ARR has been found, the current node will be split in 236.
SPLIT: this function applies the ARR foundExpression to the pairs in the data subset present in the node. If the result is 0 for a pair, it is propagated down the decision tree to the left child node of the current node. If the result is not 0, it is sent to the right child node.
MAJOR: designates the most represented label in the pairs that have reached the current node. It is selected as the major label.

The method described above produces a decision tree T for use in predicting system operating states based on the measurement data provided thereto as input (in a vector of observable variables having the same format as that used for training/constructing the decision tree).

According to at least one embodiment, the decision tree T is tested using the test data set JDT. During this test, each of the (vector, label) pairs in the test set JDT is successively presented as input to the decision tree T. For each pair, the decision tree T is traversed until it reaches a leaf node. The label associated with this leaf node is considered and compared with that of the pair presented as input. The number of pairs that were correctly predicted is then counted and a score is obtained. If the score is above a given threshold, the decision tree T is considered suitable for use in diagnosing the system S. If not, the construction can be repeated for example using a larger training data set and other parameters (choice of operators to search for classification functions for example).

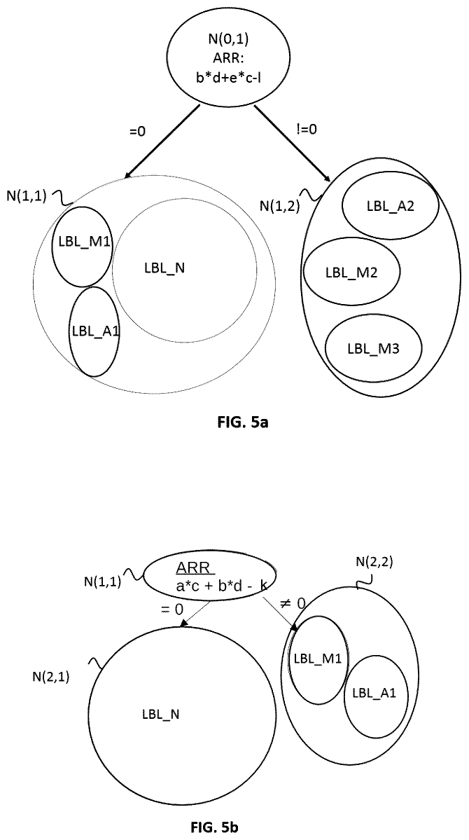

In relation to FIG. 6, the steps of a method for diagnosing a state of system S are now described according to an at least one embodiment of the invention. This method is implemented for example by a device 200 which will be described above. This device 200 is configured to access the decision tree T constructed and made available by the device 100.

In 60, a vector of measurement data of observable variables is obtained having the same format as the vectors used to construct the decision tree T. These have for example been measured and transmitted by sensors such as CT1, CT2, . . . . CT7 in FIG. 1b, according to one or more embodiments of the invention. As an illustrative example, the decision tree T is considered in FIG. 5C, according to one or more embodiments of the invention.

In 61, the decision tree T is executed for the data vector V obtained. The vector V is presented at root node N(0, 1), where the ARR equation associated with that node (b*d+e*c−g) is applied. The decision to propagate the vector V to one or other branch of the lower level LVL1 is based on whether or not the data vector verifies this equation. If the equation is true for the data vector V, it is sent on the left branch to node N(1,1), otherwise it is sent on the right branch to node N(1,2). It is assumed herein by way of example that it is not verified. The vector V is therefore sent to node N(1,2). The node N(1, 2) is associated with the ARR equation: a*c+b*d−k. In the same way, it is sent to the lower level LV2 of the tree based on the result obtained. It is assumed herein that the ARR of node N(1,2) is not verified by the vector V. It is therefore propagated up to node N(2,4) which is a leaf node.

Such a leaf node performs diagnosis on one or more system components, ideally just one. It is associated with a state class comprising nominal class CL1 or failure class CL2. Information about the component associated with the node and the state class form the diagnosis result RS contained by the leaf node. In the example shown in FIG. 5c, leaf node N(2,4) diagnoses component M2 and uses class CL2 to indicate that it is in a fault state.

As already mentioned, it is possible that the construction of the decision tree stops before having reached leaf nodes that are all pure, that is that are each capable of isolating the failure of a particular component of the system S. This premature termination can be attributed to the training data set, and in particular to the observable variables used, which do not allow the analytical redundancy relations required to discriminate between the failures of each of the components to be established. In relation to FIG. 5c, according to one or more embodiments of the invention, this is the case for example for leaf nodes N(2,2) and N(2,3). Node N(2,2) is intended to diagnose component M1, but in reality, it has not been possible to find an ARR that allows it to isolate the failures of this component, with the result that it is unable to separate the failures of component M1 from those of component A1. Similarly, node N(2,3) is intended to diagnose component M3, but in reality, it is unable to dissociate the failures of component M3 from those of component A2.

Concerning the system S in FIG. 1b, according to one or more embodiments of the invention, it is understood that one possible reason for this failure could be the absence of sensors to collect measurement data for variables t, u, w, which constitute both outputs of components M1, M2 and M3 and inputs of components A1 and A2.

The functions, steps and methods described herein can be implemented by software (for example, via software on one or more processors, for execution on a general-purpose or special-purpose computer) and/or implemented by hardware (for example one or more electronic circuits, and/or any other hardware component).

The present description thus relates to a computer software or program, capable of being executed by a host device (for example, one of the devices 100 and 200) by means of one or more data processors, this program/software comprising instructions for causing the execution by this host device of all or some of the steps of one or more of the methods described herein. These instructions are intended to be stored in a memory of the host device, loaded and then executed by one or more processors of this host device so as to cause this host device to execute the method, according to one or more embodiments of the invention.

This software/program may be coded by means of any programming language, and be in the form of source code, object code, or intermediate code between source code and object code, such as in a partially compiled form, or in any other desirable form.

The host device can be implemented by one or more physically separate machines. The host device can have the overall architecture of a computer, including the constituents of such an architecture: data memory(s), processor(s), communication bus, hardware interface(s) for connecting this host device to a network or other equipment, user interface(s), etc.

In at least one embodiment, some or all of the steps of the programming method or other method described herein are implemented by a programming device provided with means for implementing those steps of this method.

These means may comprise software means (for example, instructions for one or more components of a program) and/or hardware means (for example, data memory(ies), processor(s), communication bus, hardware interface(s), etc.).

These means may comprise for example one or more circuits configured to execute one or more or all of the steps of one of the methods described herein. These means may comprise for example at least one processor and at least one memory comprising program instructions configured to, when executed by the processor, cause the device to perform one or more or all of the steps of one of the methods described herein.

FIG. 7 shows a device 100 for constructing a decision tree for diagnosing a multi-component system or a device 200 for diagnosing a multi-component system according to one or more embodiments of the invention. In this example, the device 100, 200 is configured to implement all the steps of the method for constructing a decision tree, respectively for diagnosing a system described herein. Alternatively, it could also implement only some of these steps.

In relation to FIG. 7, according to one or more embodiments of the invention, the device 100, 200 comprises at least one processor 110, 210 and at least one memory 120, 220. The device 100, 200 may also comprise one or more communication interfaces. In this example, the device 100, 200 comprises network interfaces 130, 230 (for example, network interfaces for wired/wireless network access, including an Ethernet interface, a WIFI interface, etc.) connected to the processor 110, 210 and configured to communicate via one or more wired/wireless communication links and user interfaces 140, 240 (for example, a keyboard, a mouse, a display screen, etc.) connected to the processor. The device 100, 200 may also comprise one or more media players 150, 250 for reading a computer-readable storage medium (for example, a digital storage disk (CD-ROM, DVD, Blue Ray, etc.), a USB stick, etc.). The processor 110, 210 is connected to each of the other aforementioned components in order to control the operation thereof.

The memory 120, 220 may comprise a random-access memory (RAM), cache memory, non-volatile memory, backup memory (for example, programmable or flash memories), read-only memory (ROM), a hard disk drive (HDD), a solid-state drive (SSD) or any combination thereof. The ROM of the memory 120, 220 can be configured to store, inter alia, an operating system of the device 100, 200 and/or one or more computer program codes of one or more software applications. The RAM of the memory 120, 220 can be used by the processor 110, 210 for temporary data storage.

The processor 110, 210 can be configured to store, read, load, execute and/or else process instructions stored in a computer-readable storage medium and/or in the memory 120, 220 so that, when the instructions are executed by the processor, the device 100, 200 performs one or more or all of the steps of the construction, respectively diagnosis, method described herein. Means implementing a function or set of functions may correspond in this document to a software component, a hardware component or even a combination of hardware and/or software components, capable of implementing the function or set of functions, as described below for the means related.

The present description also relates to an information storage medium readable by a data processor, and comprising instructions of a program as mentioned above, according to one or more embodiments of the invention.

The information storage medium can be any hardware means, entity or apparatus, capable of storing the instructions of a program as mentioned above. Usable program storage media include ROM or RAM, magnetic storage media such as magnetic disks and tapes, hard disks or optically readable digital data storage media, or any combination thereof. In some cases, the computer-readable storage medium is non-transitory. In other cases, the information storage medium may be a transient medium (for example, a carrier wave) for transmitting a signal (electromagnetic, electrical, radio or optical signal) containing program instructions. This signal can be routed via a suitable wired or wireless transmission means: electrical or optical cable, radio or infrared link, or by other means.

At least one embodiment of the invention as set forth above can be applied to any complex static industrial system, provided that measurement data are available for observable variables representing an operating state of the constituent components thereof. In relation to FIG. 8, according to one or more embodiments of the invention, a description is now given by way of illustrative example of a system S′ comprising two water tanks T1 and T2 connected by a valve Vb. A valve Vo controls the outlet of the tank T2. Both valves can be in the open or closed state. The tank T1 is supplied by a pump P1 capable of delivering water at a flow rate Qp. This pump is regulated by a controller PI.

One objective of this system is to maintain a constant outlet flow rate Qo. Any deviation from this objective is considered a faulty operating state, or fault/failure.

In this example, the following observable variables are considered (some of which are shown in FIG. 8, others not): mP1 pressure measured in tank 1, mP2 pressure measured in tank 2, my1 water level in tank T1, my2 water level in tank T2, mUp output signal from controller PI, mUo position of valve Vo, mUb position of valve Vb, mQp output flow rate from pump P1, mQo output flow rate from system S′.

A distinction is made between 13 operating states of the various components of the system S′: nominal operating state, failure state of the controller PI, failure state of the pump P1, failure state of the position sensor mUb of the valve Vv, failure state of the sensor my1, failure state of the sensor my2, leak state in tank T1 (relates to the observable variables my1, mP1. On FIG. 8, according to one or more embodiments of the invention, a leak rate Qf1 is indicated), leak state in tank T2 (relates to observable variables my2, mP2. On FIG. 8, leak rate Qf2 is indicated), abnormal water level state in tank T2, valve Vb closed state and valve Vb open state.

As a result, the training data set comprises a vector made up of the foregoing observable variables and one of the operating state labels just mentioned. To implement the decision tree construction method, a set of operators O is created comprising for example the following operators: +, *, −, /, sqrt, abs, sign, cos, sin.

It is understood that the set of operators O can be defined in various ways, for example by a user of the system who has a certain intuition of how it works. In this case, it is assumed that there will be square relationships hence the choice of the root operator. On the other hand, it is assumed that there is no trigonometric relationship in the system, therefore the cos and sin operators are not selected.

Of course, at least one embodiment of the invention can be applied to other systems, for example to a building whose solidity state is to be diagnosed in order to assess the risk of collapse. One objective could be to maintain a fixed height or a 90° angle between each of its walls and the floor. The variables would be the physical quantities that govern the position of walls, ceilings, etc., and the diagnosis is one of several given states of solidity of the building, according to one or more embodiments of the invention.

APPENDIX
allARRs ← emptyList
currentNodes ← rootNode
while currentNodes is not EMPTY do
for all node ∈ currentNodes do
if node is PURE with label then
node is LEAF
node.label ← label
else
GENERATE pairs
while not CHECK f oundExpression AND pair REMAINS do
BALANCE pair
f oundExpression ←SYMBOLIC CLASSIFICATION on pair
end while
if foundExpression EXISTS then
allARRs ← + foundExpression
leftNode, rightNode ←SPLIT according to foundExpression
futureNodes ← +le f tNode, rightNode
else
node is LEAF
node.label ←MAJOR label
end if
end if
end for
currentNodes ← f tureNodes
end while

1. A method of constructing a decision tree to diagnose a system comprising a plurality of components, said method comprising:
obtaining a training data set comprising pairs, wherein one pair of said pairs comprising
a vector of measured values of observable variables representing an operation of the system, and
an associated label,
wherein the associated label belongs to a group of labels comprising
a label representing a nominal operating state of said system, and
a plurality of labels each representing a failure state of said system, each failure state of each label of said labels associated with at least one component of said plurality of components of said system,
processing a current node of the decision tree associated with a subset of the training data set comprising a current data set, derived from the training data set, said processing comprising, when at least one splitting criterion is satisfied,
splitting the current node into a first child node and a second child node by applying a classification function obtained from the current data set and defined to associate with a plurality of said observable variables,
a first class as a nominal class, representing the nominal operating state of the system or
a second class as a failure class, representing said failure state of said system, and
classifying the pairs of the current data set comprising a first label of the group of labels in the nominal class and the pairs of the current data set comprising a second label of the group of labels in the failure class, and
propagating said pairs classified in the nominal class in a first data subset of the first child node and said pairs classified in the failure class in a second data subset of the second child node, and
providing a decision tree to diagnose said system.

2. The method of constructing a decision tree according to claim 1, wherein said at least one splitting criterion comprises an impurity criterion and said method further comprises
checking the impurity criterion, comprising determining a ratio between a number of pairs in the current data set associated with a given label in the group of labels and a total number of pairs in said current data set, the impurity criterion being checked when the ratio is below a given purity threshold.

3. The method of constructing a decision tree according to claim 2, wherein the processing of the current node further comprises, when the impurity criterion is satisfied,
selecting the first label and the second label in the group of labels, as a label pair, the first label and the second label being distinct and represented in the pairs of the current data set,
determining a search data set using at least some of the current data set and based on the label pair that is selected, and
searching for the classification function using symbolic classification based on a given set of operators and the pairs in the search data set.

4. The method of constructing a decision tree according to claim 3, wherein said at least one splitting criterion comprises a classification performance criterion of the classification function obtained, and in that the method further comprises, prior to said splitting, verifying said classification performance criterion, said verifying comprising
determining a first ratio between a number of pairs in the current data set comprising the label representing the nominal operating state classified by the classification function in the nominal class out of a total number of pairs in the current data set comprising said label,
determining a second ratio between a number of pairs in the search data set classified by the classification function in a class from the nominal class and the failure class which corresponds to their label and a total number of pairs in the search data set, and
comparing the first ratio and the second ratio respectively with a first given threshold and a second given threshold, the classification performance criterion being verified when the first given threshold and the second given threshold are crossed.

5. The method of constructing a decision tree according to claim 1, wherein, after said splitting the current node and as long as at least one next node remains unprocessed according to a given sequence of the decision tree, the method further comprises iterating the processing for the at least one next node.

6. The method of constructing a decision tree according to claim 4, wherein, when the classification performance criterion has not been verified, the processing of the current node further comprises selecting a new pair of labels as long as there remains one pair of labels not yet selected in the current data set.

7. The method of constructing a decision tree according to claim 3, wherein, when the current data set comprises pairs comprising the label representing the nominal operating state, the label pair that is selected comprises said label as the first label and a label representing a fault state as the second label.

8. The method of constructing a decision tree according to claim 7, wherein the search data set comprises all of the pairs in the current data set comprising the label, from the first label and the second label, which is least represented in number in the current data set, and as many pairs of the current data set comprising another label thereof.

9. The method of constructing a decision tree according to claim 3, wherein, when the current data set does not comprise any pairs comprising the label representing the nominal operating state, the current data set comprising a first number of pairs comprising the first label and a second number of pairs comprising the second label, said first number of pairs being greater than the second number of pairs, the search data set is formed of a third number of pairs comprising the first label, less than or equal to the second number of pairs, the second number of pairs and a fourth number of pairs comprising the label representing the nominal operating state of the system, the fourth number being equal to a difference between the second number of pairs and the third number of pairs.

10. The method of constructing a decision tree according to claim 3, wherein the searching for the classification function by symbolic classification comprises implementation of a genetic algorithm that comprises
randomly generating a plurality of candidate functions associating an actual classification value with several of said observable variables,
for each candidate function that is generated, evaluating the each candidate function comprising applying said each candidate function to the search data set, for the actual classification value obtained, and applying a transformation function to said actual classification value of said each candidate function, with binary transformed values being obtained, and determining a fitness score for the each candidate function of the search data set from said binary transformed values,
selecting at least one candidate function from the plurality of candidate functions generated using the fitness score, said at least one candidate function being associated with at least one best fitness score according to a given criterion,
mutating the at least one candidate function that is selected and iterating the evaluating and the selecting on at least one candidate function that is mutated, until at least one stopping criterion is not satisfied.

11. The method of constructing a decision tree according to claim 10, wherein said at least one stopping criterion comprises at least
determining a stagnation of the fitness score during a given number of iterations, and a maximum number of iterations of the evaluating and the selecting that reached.

12. The method of constructing a decision tree according to claim 1, further comprising
obtaining said measured values of said observable variables representing an operation of said system via sensors, said vector comprising the measured values of said observable variables being formed;
applying to said vector said decision tree that is constructed, said applying comprising propagating the vector in the decision tree up to an unsplit node comprising a leaf node, said leaf node being associated with at least one label belonging to the group of labels comprising the label representing the nominal operating state of the system and said plurality of labels each representing the failure state of the system,
providing a diagnosis result, comprising said at least one label associated with the leaf node of the decision tree comprising said vector.

13. A device that constructs a decision tree to diagnose a system comprising a plurality of components), said device comprising:
at least one memory and at least one processor configured to
obtain a training data set comprising pairs, one pair of said pairs comprising a vector of measured values of observable variables representing an operation of the system and an associated label, the associated label belonging to a group of labels comprising a label representing a nominal operating state of said system and a plurality of labels each representing a failure state of one component of the plurality of components,
process a current node associated with a subset of the training data set comprising a current data set, derived from the training data set, wherein said process comprises, when at least one splitting criterion is satisfied,
splitting the current node into a first child node and a second child node by applying a classification function obtained from the current data set and defined to associate with a plurality of said observable variables,
a first class comprising a nominal class, representing the nominal operating state of the system or
a second class comprising a failure class, representing said failure state of said system, and
classifying the pairs of the current data set comprising a first label of the group of labels in the nominal class and the pairs of the current data set comprising a second label of the group of labels in the failure class, and
propagating said pairs that are classified in the nominal class in a first data subset of the first child node and said pairs that are classified in the failure class in a second data subset of the second child node, and
provide a decision tree to diagnose said system.

14. The device according to claim 13, wherein said processor is further configured to
apply to said vector said decision tree that is constructed, wherein said apply comprises
propagating the vector in the decision tree up to an unsplit node comprising a leaf node, said leaf node being associated with the label belonging to the group comprising the label representing the nominal operating state of the system and the plurality of labels each representing the failure state of said one component of the system,
provide a diagnosis result, comprising said at least one label associated with the leaf node of the decision tree comprising said vector.

15. A non-transitory computer-readable recording medium on which is stored a computer program product comprising instructions which, when executed by a computer cause the computer to execute a method of constructing a decision tree to diagnose a system comprising a plurality of components, said method comprising:
obtaining a training data set comprising pairs, wherein one pair of said pairs comprising
a vector of measured values of observable variables representing an operation of the system, and
an associated label,
wherein the associated label belongs to a group of labels comprising
a label representing a nominal operating state of said system, and
a plurality of labels each representing a failure state of said system, each failure state of each label of said labels associated with at least one component of said plurality of components of said system,
processing a current node of the decision tree associated with a subset of the training data set comprising a current data set, derived from the training data set, said processing comprising, when at least one splitting criterion is satisfied,
splitting the current node into a first child node and a second child node by applying a classification function obtained from the current data set and defined to associate with a plurality of said observable variables,
a first class as a nominal class, representing the nominal operating state of the system or
a second class as a failure class, representing said failure state of said system, and
classifying the pairs of the current data set comprising a first label of the group of labels in the nominal class and the pairs of the current data set comprising a second label of the group of labels in the failure class, and
propagating said pairs classified in the nominal class in a first data subset of the first child node and said pairs classified in the failure class in a second data subset of the second child node, and
providing a decision tree to diagnose said system.
